(19) United States
(12) Patent Application Publication
(10) Pub. No.: US 2025/0048962 A1
(43) Pub. Date: Feb. 13, 2025

(54) OPERATOR-CONTROLLED DISCHARGE CHUTE

(71) Applicant: Luke Dickerson, Dayton, OH (US)

(72) Inventor: Luke Dickerson, Dayton, OH (US)

(21) Appl. No.: 18/800,244

(22) Filed: Aug. 12, 2024

Related U.S. Application Data
(60) Provisional application No. 63/531,602, filed on Aug. 9, 2023.

(51) Int. Cl. A01D 34/71; A01D 101/00

(52) U.S. Cl. CPC A01D 34/71; A01D 2101/00

(57) ABSTRACT

An operator-controlled discharge chute is disclosed, including at least one mounting bracket, a gear motor, and a slip clutch coupled to the gear motor. An output shaft is in operable communication with the gear motor and the slip clutch and is rotatably connected to the at least one mounting bracket. A switch is in operable communication with the gear motor, the switch being configured to operate the gear motor to rotate the output shaft such that the lever-operated discharge chute is movable.

### CROSS-REFERENCE TO RELATED APPLICATIONS

The present application claims priority to U.S. Provisional Application No. 63/531,602 filed Aug. 9, 2023, titled “OPERATOR-CONTROLLED DISCHARGE CHUTE,” which is hereby incorporated by reference in its entirety.

### TECHNICAL FIELD

The embodiments generally relate to discharge chutes in use by lawn care equipment, and more specifically to lawn mower accessories and attachments.

### BACKGROUND

Lawn care is a regular task for homeowners, landscapers, and property maintenance personnel. Lawn mowers are available in various sizes to accommodate the needs of the operator. When mowing a lawn, blades rotate to cut the grass, resulting in clippings being produced from the cut end of each blade of grass. It is common more lawn mowers to include means for managing clippings to maintain a clean appearance of the lawn after mowing. Solutions include grass catchers which collect the grass clippings, guards which prevent clippings, debris and objects from being launched from the lawn mower, and discharge chutes to direct clippings, debris, and object in a safe direction.

In particular, some lawn mowers include operator-controlled discharge chutes to allow an operator to select between only “open” or “closed” settings to either allow grass clippings to escape a mower deck or prevent the same, respectively. Commonly, operator-controlled discharge chutes include a manual control mechanism, such as a lever, which allows the operator to manually open and close the discharge chute. While effective, some operators may find it difficult to perform the manual task of mechanically opening and closing the discharge chute. Further, these designs often only allow for a fully open and fully closed position of the discharge chute. Further, many operator-controlled discharge chutes are mounted such that they extend past the lawn mower deck. This exposes the operator-controlled discharge chute to contact with objects which may cause damage to its components.

### SUMMARY OF THE INVENTION

This summary is provided to introduce a variety of concepts in a simplified form that is further disclosed in the detailed description of the embodiments. This summary is not intended for determining the scope of the claimed subject matter.

The embodiments provided herein disclose an operator-controlled discharge chute, including at least one mounting bracket, a gear motor, and a slip clutch coupled to the gear motor. An output shaft is in operable communication with the gear motor and the slip clutch and is rotatably connected to the at least one mounting bracket. A switch is in operable communication with the gear motor, the switch being configured to operate the gear motor to rotate the output shaft such that the lever-operated discharge chute is movable.

In one aspect, the discharge blocker plate prevent clippings or debris from escaping a mower deck.

In one aspect, the discharge blocker plate is connected to a blocker plate shaft.

In one aspect, the blocker plate shaft is hingedly attached to the mower deck via a front shaft mount and a rear shaft mount.

In one aspect, the slip clutch and the gear motor are configured to rotate the blocker plate shaft to enable an operator to open or close the discharge blocker plate.

In one aspect, the discharge blocker plate is configured to partially open and to be configured in a closed position.

In one aspect, the switch is in electrical communication with the gear motor and the slip-clutch to enable the operator to selectively open and selectively close the discharge blocker plate.

In one aspect, the operator-controlled discharge chute enables the mounting of a grass catcher to the mower deck.

The disclosed operator-controlled discharge chute (OCDC) allows the operator of a commercial lawn mower to temporarily close off the discharge opening of the lawn mowers mower deck to prevent the discharge of grass clippings or other debris from exiting the mower deck.

A discharge blocker plate may be mounted to a shaft that is powered by a gear motor (such as a 12-volt gear motor), and the OCDC is equipped with a slip clutch that allows the discharge blocker plate to slip on the motor shaft in the event of a sideways impact.

The use of a gear motor allows the operator to position the chute blocker plate at any point between fully closed and fully open. This device replaces the manufacturer's installed chute to allow the grass clippings to either fully discharge or not be discharged at all, giving the operator more options and providing increased safety to passersby and objects that the mower operator doesn't want to damage, and preventing grass clippings from being discharged onto surfaces that would require additional cleanup, which saves significant time and effort.

Other illustrative variations within the scope of the invention will become apparent from the detailed description provided hereinafter. The detailed description and enumerated variations, while disclosing optional variations, are intended for purposes of illustration only and are not intended to limit the scope of the invention.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a perspective view of the operator-controlled discharge chute, according to some embodiments;

FIG. 2 illustrates a perspective view of the operator-controlled discharge chute in a closed configuration, according to some embodiments;

FIG. 3 illustrates a perspective view of the operator-controlled discharge chute in an open configuration, according to some embodiments; and

FIG. 4 illustrates a perspective view of the switch for the operator-controlled discharge chute, according to some embodiments.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing in detail exemplary embodiments, it is noted that the embodiments reside primarily in combinations of components related to particular devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments provided herein relate to an operator-controlled discharge chute (OCDC) prevents grass clippings and other debris from exiting the deck of a mower when in the closed or mostly closed positions, which is useful when mowing to keep mulch beds clean, prevent unnecessary mess on paved areas, prevent damage to windows, cars, or other objects, and to prevent objects from being launched at people, pets, and other items. It also allows the mower to fully discharge the clippings in wide open areas without restriction in situations where the liability of discharged debris is not a concern.

The disclosed OCDC may include a lever-operated discharge chute. The discharge chute allows the operator of a commercial lawn mower to temporarily close off the discharge opening of a lawn mower's mower deck to prevent the discharge of grass clippings or other debris from exiting the mower deck. The discharge chute is comprised of a stainless-steel mounting bracket with a front aluminum shaft support block and rear stainless steel motor support, a gearmotor drive motor with a ¾″ steel output shaft, and a ¼″ thick T6061 aluminum discharge blocker plate mounted to a 3/16″ thick stainless-steel angle and 1″ stainless steel tube shaft. The discharge blocker plate is driven via direct-drive from a gear motor. The discharge blocker plate may be approximately 18 inches long, but varying dimensions fall within the scope of this disclosure.

A tubular shaft of the blocker plate may be split at the end into three or four flanges, each 3.5 inches long, that allows the end of the tube to flex and be clamped to the gearmotor driveshaft with a T-bolt hose clamp, creating a slip clutch.

In the event that the discharge chute is forced closed or open from a sideways impact, the blocker plate can slip on the motor shaft, but immediately returns to normal operation without having to adjust the clamp.

The blocker plate shaft is secured to the front mounting block with a 1-inch pin that is designed to withstand a front-facing impact and transfer the impact force into the mounting bracket and mower deck.

The gearmotor is operated electrically with a switch that mounts to the steering lever of the mower, allowing the operator to use the discharge chute with their thumb, thus never having to remove their hands from the controls to operate the discharge chute. The motor, switch, and harness are protected from electrical overload with an auto-reset 30-amp breaker.

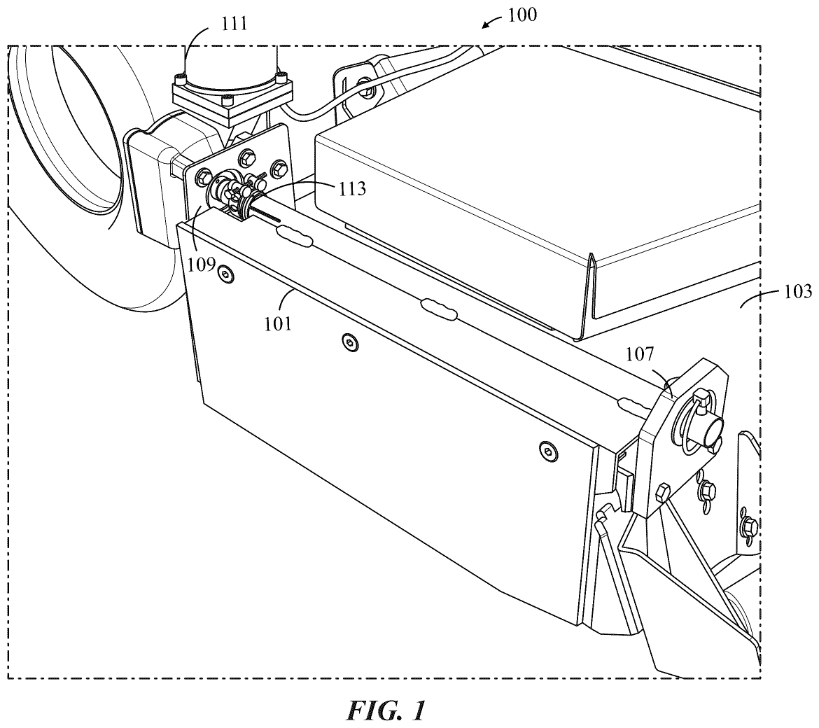

FIG. 1 illustrates an OCDC assembly 100 including a discharge blocker plate 101 constructed and arranged to prevent clippings or debris from escaping a mower deck 103. The discharge blocker plate 101 may be connected to a blocker plate shaft 105 hingedly attached to the mower deck 103 via front and rear shaft mounts 107,109 and a gear motor 111 may be in operable communication with a slip clutch 113 constructed and arranged to rotate the blocker plate shaft 105 via direct drive during use, allowing an operator to open or close the discharge block or plate to allow debris or clippings to escape the mower deck 103. Additionally, the gear motor 111, slip clutch 113, blocker plate shaft 105, and discharge blocker plate 101 may be constructed and arranged to allow for partial opening of the discharge blocker plate 101 such as, but not limited to, 25% open, 50% open, 75% open, or the like.

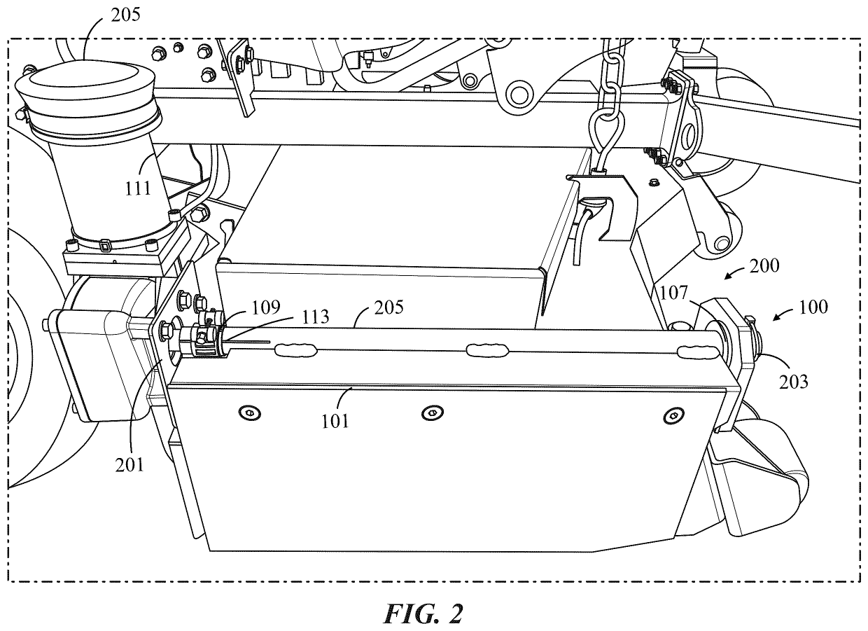

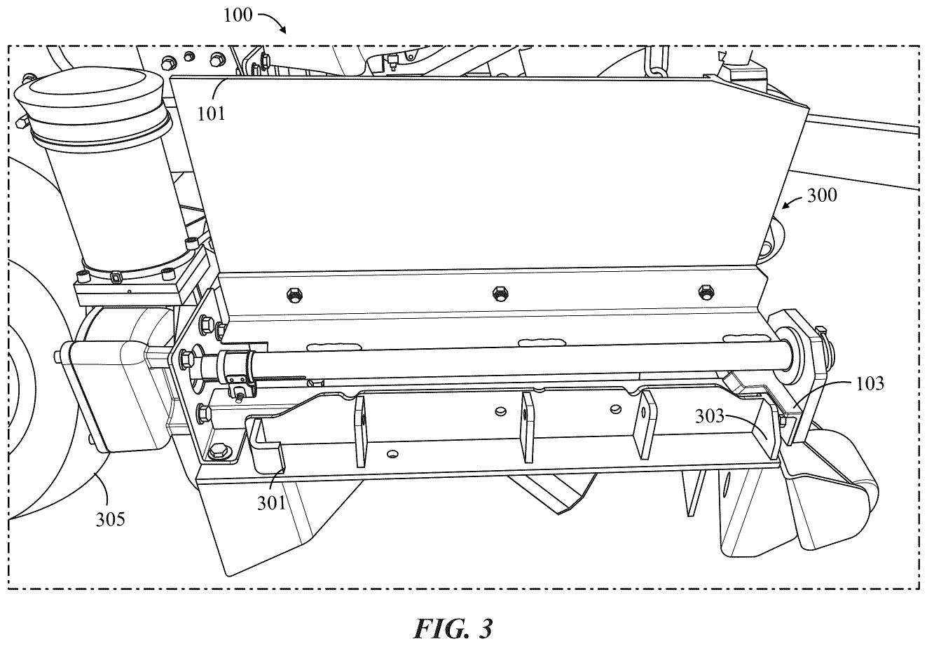

FIG. 2 illustrates an OCDC 100 in a closed position 200, including a discharge blocker plate 101 constructed from heavy-duty stainless steel and aluminum. The OCDC may include blocker plate mount brackets 201,203 to prevent grass clippings from blowing up toward a mower operator. As previously described, front and rear shaft mounts 107,109 allow the discharge blocker plate 101 to rotate with the blocker plate shaft 105. Front and rear shaft mounts 107,109 may be constructed and arranged to withstand loads from front impacts to the OCDC. A 60 RPM gear motor 111 in operable communication with the slip clutch 113 and the blocker plate shaft 105 may be configured to allow infinite blocker plate positioning between a closed position 200 and an open position (see FIG. 3), such as a partially open position. A rubber boot 205 may enclose sensitive electronic components in operable communication with the gear motor 111 or slip clutch 113.

FIG. 3 illustrates an OCDC 100 in an open position 300, wherein the blocker plate 101 is rotated upwards into the open position via a switch operated by a user. The OCDC 100 may be configured to allow grass catchers (not shown) to be mounted to the mower deck 103 without the removal of the OCDC from a mower 305. The OCDC may be securely mounted to a mower deck 103 via three mounting bolts at mounting locations 301,303. In such, the blocker plate 101 directs clippings and/or debris into the grass catcher.

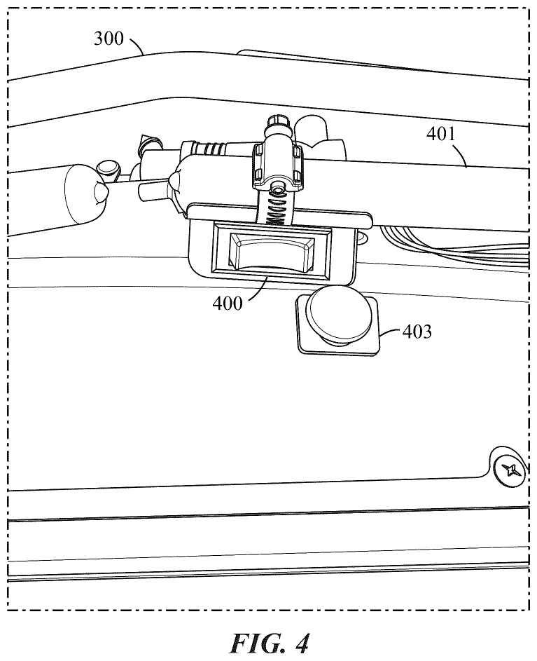

FIG. 4 illustrates a switch 400 for operating an OCDC. The switch 400 may be mounted anywhere on a mower 305 such as, but not limited to, a mower handle 401, a control panel 403, a steering level, etc. The switch 400 may be in operable communication with the electronic components, gear motor, or clutch of the OCDC to allow a user to control opening or closing of the discharge blocker plate. The switch 400 may be in wired or wireless communication with the gear motor and/or slip clutch such that operating the switch causes the movement of the blocker plate. The switch 400 may be a toggle switch where pressing one side of the switch 400 opens the blocker plate, while pressing another side of the switch 400 closes the blocker plate. In such, the switch 400 may be biased to the center position which stops movement of the blocker plate.

In some embodiments, the gear motor may be mounted at the front of the mounting bracket or at the rear of the mounting bracket, The mounting location of the gear motor may be dependent on the specific lawn mower which the operator-controlled discharge chute is being used with.

In some embodiments, the slip clutch may include a two-piece clamping collar rather than the T-bar clamp shown in the exemplary drawing figures.

In some embodiments, the switch may be moveable via the operator, such that it can be mounted on various parts of the lawn mower. This allows the operator to customize the control layout and select a preferred location of the switch based on their personal preferences.

It is to be understood that the operator-controlled discharge chute described herein can be attached to various lawn mower configurations including walk-behind lawn mowers, riding lawn mowers, zero-turn lawn mowers, etc. For example, the switch may be positioned on the grip handle of a walk-behind lawn mower or on the steering levers of riding lawn mowers.

Unless otherwise defined, all technical and scientific terms used herein have the same meaning as commonly understood by one of ordinary skill in the art to which this invention belongs. All publications, patent applications, patents, and other references mentioned herein are incorporated by reference in their entirety to the extent allowed by applicable law and regulations. The systems and methods described herein may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

The foregoing is provided for purposes of illustrating, explaining, and describing embodiments of this disclosure. Modifications and adaptations to these embodiments will be apparent to those skilled in the art and may be made without departing from the scope or spirit of this disclosure.

As used herein and in the appended claims, the singular forms “a”, “an”, and “the” include plural referents unless the context clearly dictates otherwise.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

In many instances entities are described herein as being coupled to other entities. It should be understood that the terms “coupled” and “connected” (or any of their forms) are used interchangeably herein and, in both cases, are generic to the direct coupling of two entities (without any non-negligible (e.g., parasitic intervening entities) and the indirect coupling of two entities (with one or more non-negligible intervening entities). Where entities are shown as being directly coupled together or described as coupled together without description of any intervening entity, it should be understood that those entities can be indirectly coupled together as well unless the context clearly dictates otherwise.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described herein. A variety of modifications and variations are possible in light of the above teachings without departing from the following claims.

What is claimed is:

1. An operator-controlled discharge chute, comprising:
at least one mounting bracket;
a gear motor;
a slip-clutch operably coupled to the gear motor;
an output shaft in operable communication with the gear motor and the slip clutch, and being rotatably connected to the at least one mounting bracket; and
a switch in operable communication with the gear motor, the switch being configured to operate the gear motor to rotate the output shaft such that the lever-operated discharge chute is movable.

2. The operator-controlled discharge chute of claim 1, further comprising a discharge blocker plate to prevent clippings or debris from escaping a mower deck.

3. The operator-controlled discharge chute of claim 2, wherein the discharge blocker plate is connected to a blocker plate shaft.

4. The operator-controlled discharge chute of claim 3, wherein the blocker plate shaft is hingedly attached to the mower deck via a front shaft mount and a rear shaft mount.

5. The operator-controlled discharge chute of claim 4, wherein the slip clutch and the gear motor are configured to rotate the blocker plate shaft to enable an operator to open or close the discharge blocker plate.

6. The operator-controlled discharge chute of claim 5, wherein the discharge blocker plate is configured to partially open and to be configured in a closed position.

7. The operator-controlled discharge chute of claim 6, wherein the switch is in electrical communication with the gear motor and the slip-clutch to enable the operator to selectively open and selectively close the discharge blocker plate.

8. The operator-controlled discharge chute of claim 7, wherein the operator-controlled discharge chute enables the mounting of a grass catcher to the mower deck.

9. An operator-controlled discharge chute, comprising:
at least one mounting bracket to mount a discharge blocker plate to a mower deck;
a gear motor operably coupled to a slip-clutch;
an output shaft in operable communication with the gear motor and the slip clutch, and being rotatably connected to the at least one mounting bracket;
a switch mounted to a steering lever, the switch in electrical communication with the gear motor, the switch being configured to operate the gear motor to rotate the output shaft such that the lever-operated discharge chute is movable between an open configuration and a closed configuration.

10. The operator-controlled discharge chute of claim 9, wherein the discharge blocker plate prevents clippings or debris from escaping a mower deck.

11. The operator-controlled discharge chute of claim 10, wherein the discharge blocker plate is connected to a blocker plate shaft.

12. The operator-controlled discharge chute of claim 11, wherein the blocker plate shaft is hingedly attached to the mower deck via a front shaft mount and a rear shaft mount.

13. The operator-controlled discharge chute of claim 12, wherein the slip clutch and the gear motor are configured to rotate the blocker plate shaft to enable an operator to open or close the discharge blocker plate.

14. The operator-controlled discharge chute of claim 13, wherein the switch is in electrical communication with the gear motor and the slip-clutch to enable the operator to selectively open and selectively close the discharge blocker plate, wherein the operator can open the discharge blocker plate in increments.

15. The operator-controlled discharge chute of claim 14, wherein the operator-controlled discharge chute enables the mounting of a grass catcher to the mower deck.

16. An operator-controlled discharge chute, comprising:
at least one mounting bracket to mount a discharge blocker plate to a mower deck;
a gear motor operably coupled to a slip-clutch, the slip clutch in operable communication with an output shaft, the output shaft rotatably mounted to the at least one mounting bracket to rotate the discharge blocker plate;
a front shaft mount and a rear shaft mount to connect the blocker plate shaft to the at least one mounting bracket, the front shaft mount and the rear shaft mount to absorb impact force imparted to the discharge blocker plate; and
a switch mounted to a steering lever, the switch in electrical communication with the gear motor, the switch being configured to operate the gear motor to rotate the output shaft such that the lever-operated discharge chute is selectively moveable between an open configuration and a closed configuration.

17. The operator-controlled discharge chute of claim 16, wherein the switch is mounted to the control panel of the mower to enable efficient access to the switch via the operator.

18. The operator-controlled discharge chute of claim 17, wherein the switch is a toggle switch having an open direction and a close direction.

19. The operator-controlled discharge chute of claim 18, wherein the slip-clutch is slotted at one end and is clamped to the output shaft.

20. The operator-controlled discharge chute of claim 19, further comprising a grass catcher connected to the mower deck to collect clippings and debris directed into the grass catcher via the discharge blocker plate.
